(19) United States
(12) Patent Application Publication
(10) Pub. No.: US 2022/0394451 A1
(43) Pub. Date: Dec. 8, 2022

(54) METHOD AND SYSTEM TO DETERMINE WAIT TIME FOR DISASTER SERVICE REGISTRATION

(71) Applicant: SAMSUNG ELECTRONICS CO., LTD., Suwon-si (KR)

(72) Inventors: Lalith KUMAR, Bangalore (IN); Aman AGARWAL, Bangalore (IN); Kailash Kumar JHA, Bangalore (IN); Mahmoud WATFA, Staines (GB); Samiran BHOWMIK, Bangalore (IN)

(21) Appl. No.: 17/805,183

(22) Filed: Jun. 2, 2022

(30) Foreign Application Priority Data
Jun. 2, 2021 (IN) 202141024639
May 18, 2022 (IN) 2021 41024639

(51) Int. Cl. H04W 4/90; H04W 8/18; H04W 48/16; H04W 48/18

(52) U.S. Cl. CPC H04W 4/90; H04W 8/183; H04W 48/16; H04W 48/18

(57) ABSTRACT

Embodiments herein disclose methods for handling operation of a UE during a disaster situation by the UE. The method includes initiating a wait timer upon selecting a forbidden public land mobile network (FPLMN) to receive a disaster roaming service. Further, the method includes determining whether at least one of: a MS is registered via a non-3GPP access or 3GPP access to another allowable PLMN, the FPLMN has stopped broadcasting a disaster related indication, and the FPLMN has stopped broadcasting the PLMN with the disaster condition. Further, the method includes stopping the wait timer and performing a PLMN selection procedure based on the determination. The provided method optimizes the operations in disaster situations.

### CROSS-REFERENCE TO RELATED APPLICATIONS

This application is based on and claims priority under 35 U.S.C. § 119 to Indian Patent Application No. 202141024639 filed Jun. 2, 2021, and Indian Patent Application No. 202141024639 filed May 18, 2022, the disclosures of which are incorporated by reference herein in their entirety.

### BACKGROUND

### 1. Field

Embodiments disclosed herein relate to wireless communication networks, and more particularly to methods and a user equipment (UE) for handling an operation of the UE during a disaster situation based on a wait timer in the wireless communication networks.

### 2. Description of Related Art

The purpose of minimization of service interruption (MINT) is to minimize interruption of service to users when the wireless communication network to which the users are subscribed cannot provide a service due to a disaster such as e.g., a fire, earthquake or the like, by enabling the users to obtain service on other networks, while at the same time protecting those other networks from congestion.

Consider that the PLMN D is subject to disaster and the PLMN A is alive (forbidden PLMN) and not subject to the disaster. The terms disaster based service and disaster roaming service have used interchangeably herein and have the same meaning.

When a disaster condition applies, all UEs of the PLMN with disaster condition that are located in the area, where the disaster condition applies will look for another PLMN in that area and attempt to register on the PLMN to obtain service. This could cause a large number of UEs to migrate from the PLMN with disaster condition to another PLMN providing disaster roaming service, and attempt registration at around the same time, leading to signalling overload in the other PLMN due to the massive influx of roamers. Consequently, mechanisms are needed to prevent signalling overload in the PLMNs without a disaster condition. In prior art to handle this the UE can be provisioned with a disaster roaming wait range, which the UE may use to determine how long to wait before initiating registration on the selected PLMN after performing a PLMN selection triggered by a notification that a disaster condition applies to the registered or allowable PLMN.

But while the random or wait timer is running it is important to analyze the environment for example by monitoring information broadcasted from current camped FPLMN or any other PLMN available in the area, the UE may also monitor the activities on non-3GPP access. All this aspects are not considered in the prior art and prior art forces the UE to initiate registration on the PLMN-A (FPLMN) when timer expires without analyzing any change in the conditions before start of the timer and end of the timer. This is not desirable for below reasons:

1. If PLMN-A is aware that disaster condition is alleviated then the PLMN-A may reject the UE, the UE may lose the context, and delay reselecting to PLMN providing normal services.

2. If PLMN-A is not aware that disaster condition is alleviated then UE can remain registered with PLMN-A incurring heavy charges to HPLMN, with reduced an amount of services to the user as part of disaster roaming service.

FIG. 1 depicts a scenario of handling operation of a UE (100) during a disaster situation, according to prior arts. Referring to the FIG. 1, at 1, a PLMN-1 (200) faces disaster condition. At 2, the PLMN-1 (200) indicates that the PLMN-1 (200) is in a disaster condition to a FPLMN (300). The FPLMN (300) broadcasts that the PLMN-1 (200) is in the disaster condition. At 3, after seeing the broadcasts from the FPLMN (300), the UE (100) detects that there is disaster condition on the PLMN-1 (200). The UE (100) selects the FPLMN (300) and starts the wait timer. At 4, after some time, the PLMN-1 disaster condition ends. At 5, the PLMN-1 (200) indicates disaster condition has ended to the FPLMN (300). At 6, the wait timer expires at the UE (100). The UE (100) triggers registration on the FPLMN (300) to receive disaster roaming service. The prior art forces the UE (100) to initiate registration on the PLMN-A (FPLMN) when timer expires, which is not desirable for following reasons: If the FPLMN (300) is aware that the disaster condition is alleviated then the FPLMN may reject the UE (100), the UE (100) may lose the context, and delay reselecting to PLMN providing normal services because the UE (100) ended up waiting for wait timer. If PLMN-A (i.e., FPLMN) is not aware that the disaster condition is alleviated then the UE (100) can remain registered with PLMN-A incurring heavy charges to a HPLMN, with reduced amount of services to the user as part of disaster roaming service.

It is desired to solve or at least provide alternate ways of solving this problem.

The principal object of embodiments herein is to disclose methods and a UE for handling operation of the UE during a disaster situation based on a wait timer. The provided method optimizes the operations in disaster situations without signalling overload.

### SUMMARY

Accordingly, the embodiments herein provide methods for handling operation of a UE during a disaster situation. The method includes initiating, by the UE, a wait timer upon selecting a forbidden public land mobile network (FPLMN) to receive a disaster roaming service. Further, the method includes determining, by the UE, that at least one of: a mobile station (MS) is registered via a non-3^{rd} generation partnership project (3GPP) access or 3GPP access to another allowable PLMN, the FPLMN has stopped broadcasting a disaster related indication, and the FPLMN has stopped broadcasting the PLMN with the disaster condition. Further, the method includes stopping, by the UE, the wait timer and performing a PLMN selection procedure based on the determination.

In an embodiment, a wait timer is a timer started with a generated random number within a disaster roaming wait range configured by a home public land mobile network (HPLMN).

Accordingly, the embodiments herein provide methods for handling operation of a UE during a disaster situation. The method includes detecting, by the UE, that an emergency service is initiated. Further, the method includes stopping, by the UE, a wait timer based on the detection, wherein the wait timer is initiated upon selecting a FPLMN to receive disaster roaming service.

Accordingly, the embodiments herein provide a UE including a controller coupled with a processor and a memory. The controller is configured to initiate a wait timer upon selecting a forbidden public land mobile network (FPLMN) to receive a disaster roaming service Further, the controller is configured to determine that at least one of: a MS is registered via a non-3GPP access or a 3GPP access to another allowable PLMN, the FPLMN has stopped broadcasting a disaster related indication, and the FPLMN has stopped broadcasting the PLMN with the disaster condition. The controller is configured to stop the wait timer and perform a PLMN selection procedure based on the determination.

Accordingly, the embodiments herein provide a UE including a controller coupled with a processor and a memory. The controller is configured to detect that an emergency service is initiated and stop a wait timer based on the detection, wherein the wait timer is initiated upon selecting a FPLMN to receive disaster roaming service.

These and other aspects of the embodiments herein will be better appreciated and understood when considered in conjunction with the following description and the accompanying drawings. It should be understood, however, that the following descriptions, while indicating at least one embodiment and numerous specific details thereof, are given by way of illustration and not of limitation. Many changes and modifications may be made within the scope of the embodiments herein without departing from the scope thereof, and the embodiments herein include all such modifications.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF FIGURES

The embodiments disclosed herein are illustrated in the accompanying drawings, throughout which like reference letters indicate corresponding parts in the various figures. The embodiments herein will be better understood from the following description with reference to the drawings, in which:

FIG. 1 illustrates a scenario of handling operation of a UE during a disaster situation according to prior arts;

FIG. 2 illustrates a scenario, wherein the time taken for a UE to select the PLMN is random according to embodiments as disclosed herein;

FIG. 3 illustrates various hardware components of the UE for handling operation of the UE during the disaster situation based on a wait timer according to embodiments as disclosed herein; and

FIG. 4 and FIG. 5 are flowcharts illustrating methods for handling operation of a UE during the disaster situation based on a wait timer according to embodiments as disclosed herein.

### DETAILED DESCRIPTION

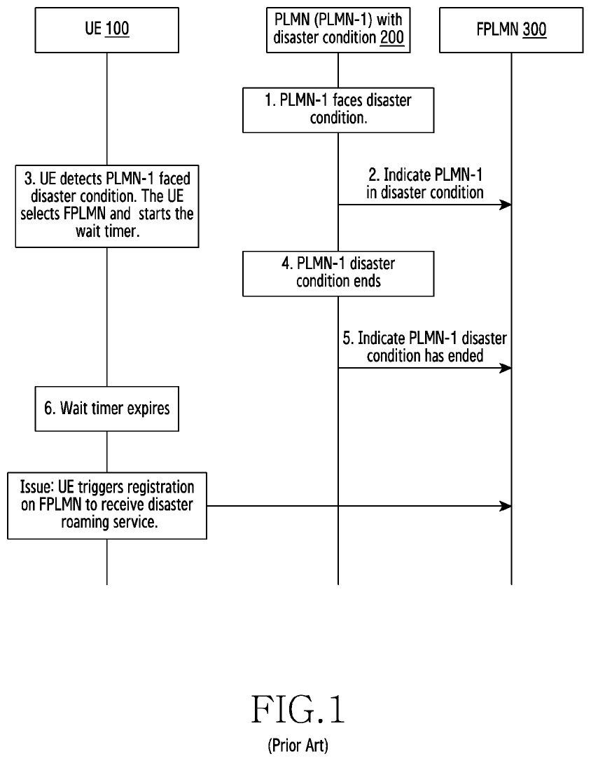

FIGS. 1 through 5, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein can be practiced and to further enable those of skill in the art to practice the embodiments herein. Accordingly, the examples should not be construed as limiting the scope of the embodiments herein.

Embodiments herein use the terms “PLMN search” and “PLMN selection” interchangeably herein.

The embodiments herein achieve methods for handling operation of a UE during a disaster situation. The method includes initiating, by the UE, a wait timer upon selecting a forbidden public land mobile network (FPLMN) to receive a disaster roaming service. Further, the method includes determining, by the UE, that at least one of: a MS is registered via a non-3GPP access or a 3GPP access to another allowable PLMN, the FPLMN has stopped broadcasting a disaster related indication, and the FPLMN has stopped broadcasting the PLMN with the disaster condition. Further, the method includes stopping, by the UE, the wait timer and performing a PLMN selection procedure based on the determination.

The method can be used for determining the wait time for the UE to look for another PLMN (other than the PLMN to which the UE was registered) in the area (where the UE is located) and attempt to register on the PLMN to obtain service, on the disaster condition occurring. The provided method optimizes the operations in disaster situations without signalling overload.

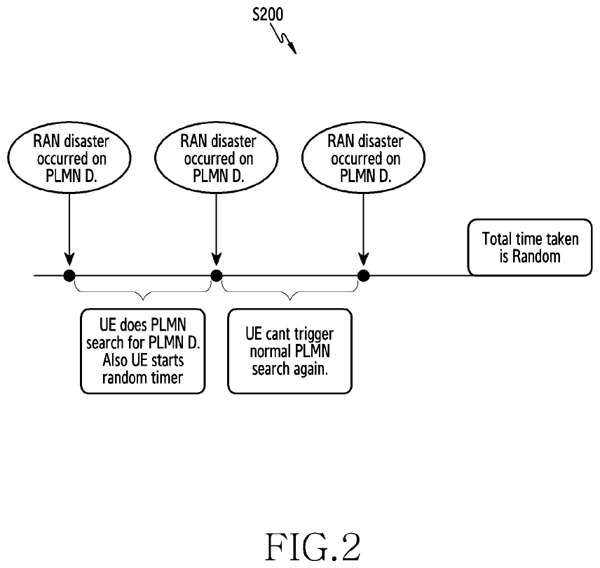

Referring now to the drawings, and more particularly to FIG. 2 to FIG. 5, where similar reference characters denote corresponding features consistently throughout the figures, there are shown at least one embodiment.

FIG. 2 illustrates a scenario (S200), wherein the time taken for a UE to select the PLMN is random according to embodiments as disclosed herein.

In an embodiment, the methods and systems can be used for enabling PLMN A to determine a disaster PLMN for a UE (assuming PLMN A is providing disaster inbound roaming services for multiple disaster PLMN's), when the UE identifies that a disaster situation has occurred, or disaster condition applies for a PLMN (PLMN D1) and the UE initiates registration on a PLMN A for disaster roaming services.

When the UE identifies that a disaster situation has occurred or disaster condition applies for a PLMN (PLMN D1), and the list of PLMNs to be used while in a disaster condition includes PLMN A, then the UE can register on PLMN A and get disaster roaming services on the PLMN A. If the PLMN A is providing disaster roaming services for multiple PLMN (PLMN D1, D2, D3), then it may be necessary for the AMF to know which is the disaster PLMN corresponding to the UE in order to apply differential disaster roaming services for different UE's.

The UE determines whether the disaster situation has been revoked or removed based on one or more of the following example triggers (this should be just taken as an example events):

a) Broadcast bit of serving PLMN-A (the cell of PLMN-A on which the UE is currently camping) does not indicate support for disaster inbound roaming services, or does not indicate support for disaster inbound roaming services for the selected PLMN-D—or—PLMN-A has stopped broadcasting PLMN-D;

b) The UE finds a non-3GPP access signal or the 3GPP access signal. The UE is able get into connected mode over a PLMN. Optionally, this PLMN is not part of forbidden PLMN list or the PLMN is a HPLMN or the PLMN is an EHPLMN. Optionally, this step is true if the registration procedure is successful over a non-3GPP access or 3GPP access. Optionally, this step is true if the UE is able to find the PLMN over the non-3GPP access of the current serving country (determined over 3GPP access) or when the UE gets into connected mode over non-3GPP access;

c) if none of the PLMNs configured in the UE are known to provide disaster inbound roaming service are available in a given area; and

d) If the UE finds the PLMN which is available, allowable and not part of forbidden PLMN list stored in the UE. This PLMN can be available either on 3GPP access or non-3GPP access.

“Priority order based on 23.122” is defined as below (as in 4.4.3.1.1 Automatic Network Selection Mode Procedure).

The UE/MS selects and attempts registration on other PLMN/access technology combinations, if available and allowable, in the following order:

1) RPLMN:

i) Either the HPLMN (if the EHPLMN list is not present or is empty) or the highest priority EHPLMN that is available (if the EHPLMN list is present),

ii) Each PLMN/access technology combination in the “user controlled PLMN selector with access technology” data file in the SIM (in priority order) (UPLMN list),

iii) Each PLMN/access technology combination in the “operator controlled PLMN selector with access technology” data file in the SIM (in priority order) or stored in the ME (in priority order) (OPLMN list),

iv) Other PLMN/access technology combinations with received high quality signal in random order. Please note that high quality signal is defined in the appropriate AS specification,

v) Other PLMN/access technology combinations in order of decreasing signal quality, and

VI) FPLMN list PLMNs.

Priority order based on 23.122 except RPLMN is defined as below.

a) Follow the same order “priority order based on 23.122,” but skip RPLMN.

The network can optionally put restrictions on the time when the UE can initiate the registration procedure upon arriving in the PLMN without a disaster condition; The timer is hereafter called as wait time. The UE starts this timer when the UE is notified about disaster condition; i.e., the UE determines that disaster condition has occurred or the UE can start the moment that the UE gets into limited service or after camping (or selecting) on the PLMN-A. When the timer is running if the UE determines the disaster situation has been revoked (the conditions how the UE determines is discussed in this embodiment) the UE may stop the wait timer. The UE may not attempt and register on the PLMN providing disaster inbound roaming service (e.g., PLMN-A). The UE may perform PLMN selection procedure based on any of the priority mechanisms defined in this embodiment, if non-forbidden PLMN is available the UE may register on the same otherwise the UE may remain camped on limited service state.

In yet another embodiment, while the wait timer is running, the UE may not do the PLMN search and select another PLMN on the 3GPP access.

When the UE moves to a no service/limited service state, the UE may immediately start the random timer along with the PLMN search irrespective of whether the PLMN search is due to disaster situation or not. The UE may not wait until the UE determines that a disaster condition has happened in order to start the random timer. When the UE loses service or enters limited service, then the UE can start the random timer (as depicted in FIG. 2).

There can be 3 cases arising and the handling of UE is mentioned in detail for the 3 cases as below:

b) Case 1: If the random timer expires before the PLMN search is completed, the UE may restart the random timer again;

c) Case 2: The PLMN search has been completed and RPLMN/preferred PLMN's are not found and the random timer is still running, the UE may not trigger a normal PLMN search again for the normal service, when the random timer is running and the available PLMN list shows that there are no RPLMN/preferred PLMN's in the same region. The UE may wait for the random timer to expire, upon which the UE may trigger the registration on any PLMN which is providing disaster roaming services and is in the UE's forbidden PLMN list; and
d) Case 3: The PLMN search has been completed and RPLMN/Preferred PLMN's are found and the random timer is still running, the random timer is aborted or stopped, as the PLMN search is not due to a disaster situation and the UE can try to immediately acquire service on RPLMN/preferred PLMN's.

The network can optionally put restrictions on the time when the UE can initiate the registration procedure upon arriving in the PLMN without a disaster condition (also called as PLMN-A). This is also referred to as random timer or wait timer herein.

The network can optionally put restrictions on the time when the UE can initiate the registration procedure upon arriving back into the PLMN with a disaster condition (also called as PLMN-D). This is also referred to as random timer or wait timer herein.

While this random timer/wait timer is running, if the UE determines that there is a PLMN which can provide normal service to the UE over the 3GPP access or non-3GPP access, then the UE may stop this timer and attempt to register on the respective PLMN which is providing normal service to the UE.

When the wait timer expires, the UE may first determine if the UE still needs to use the disaster inbound roaming service; i.e., the UE is not yet registered over non-3GPP access or 3GPP access or the UE is not able to find the non-3GPP access service. The UE is not able to find any PLMN which can provide normal service to the UE; i.e., only forbidden PLMNs are available in the area and one or more of those forbidden PLMNs indicate that the forbidden PLMNs support for disaster inbound roaming service in the broadcast information. Then, the UE may trigger registration for disaster inbound roaming service.

While the wait timer is running, if the UE determines that the disaster situation has been revoked or removed as discussed in this embodiment, the UE may stop the wait timer. The UE may not initiate registration for disaster inbound roaming service. The UE may perform PLMN selection to acquire normal service as discussed in this embodiment.

While the wait timer is running, if the UE searches for the PLMN and finds the higher priority PLMN-A, but for the same selected PLMN-D:

e) The wait timer is stopped and execute the wait timer expiry actions;

f) The existing wait timer continues to run;

g) The wait timer is stopped and restarted with an initial value;

h) If the new wait timer (T2) of PLMN-A is greater than the running wait timer (T1), then the UE can set the new wait timer value to T2−T1; and

i) If the new wait timer (T2) of PLMN-A is less than the running wait timer (T1), then the UE can set the new wait timer value zero; i.e., the UE can stop the wait timer and execute the wait timer expiry actions.

While the wait timer is running, if the UE searches for the PLMN and finds the higher priority PLMN-A, but for the different PLMN-D:

j) The wait timer is stopped and execute the wait timer expiry actions;

k) The existing wait timer continues to run;

l) The wait timer is stopped and restarted with an initial value;

m) If the new wait timer (T2) of PLMN-D is greater than the running wait timer (T1), then the UE can set the new wait timer value to T2−T1; and

n) If the new wait timer (T2) of PLMN-D is less than the running wait timer (T1), then the UE can set the new wait timer value zero; i.e., the UE can stop the wait timer and execute the wait timer expiry actions.

While the wait timer is running, the UE may not be allowed to perform the PLMN search or the PLMN selection procedure. Optionally, to avoid this, the wait timer value may be less that current set timer values of background search timer for e.g., the higher priority PLMN search timer value is 2 minutes.

When the wait timer is running, the UE may stop the timer and initiate registration procedure (for example emergency registration) if emergency call or emergency PDU session establishment is pending or higher priority service is pending.

In an embodiment, “a UE may not start the wait timer” can be interpreted to set the value of the wait timer to zero seconds. The wait timer value may be set to zero seconds, irrespective of the value signalled by network or pre-configured in the UE for one or more of following situations:

a) If the emergency call was ongoing or emergency call (emergency PDU session) is established;

b) If the UE is registered on non-3GPP access and losses the service, i.e., the UE goes to IDLE mode over non-3GPP access this can make the UE to search for service over 3GPP access, the UE may determine that disaster condition has occurred. In this case, the UE may not start the wait timer, because the attempt is already randomized; i.e., when disaster occurs, the UE has not made an attempt to register on PLMN-A at the same time along with other UEs and this attempt on PLMN-A is already randomized;

c) If the UE is already registered on PLMN-A, e.g., PLMN-A1 and the UE selects some other PLMN-A, for e.g., PLMN-A2 for e.g., due to higher priority PLMN-A2 or higher priority PLMN-D is available or PLMN-A1 cell is not available; and

d) If the UE is already registered on PLMN-A for e.g., due to emergency services and now, the UE again initiates initial registration procedure for normal service or the UE executes, the UE initiated deregistration procedure or network initiated de registration procedure followed by the initial registration procedure.

If the UE is registered over non-3GPP access and is in connected mode and the UE determines that a disaster condition has occurred on 3GPP access, the UE may start the wait timer. The UE may optionally select and camp on PLMN-A. If on non-3GPP access and the UE goes to IDLE mode, the UE does not find any allowable PLMNs on 3GPP access; i.e., the UE finds only PLMNs, which are available in a Forbidden PLMN (FPLMN) list, then the UE may attempt registration on selected PLMN-A after the running wait timer expires. If the wait timer had already expired, the UE can initiate the registration for disaster inbound roaming service on PLMN-A immediately.

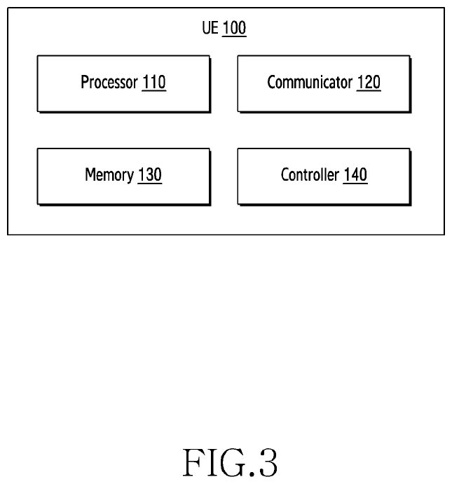

FIG. 3 illustrates various hardware components of the UE (100) for handling operation of the UE (100) during the disaster situation based on the wait timer, according to embodiments as disclosed herein. The UE (100) can be, for example, but not limited to a laptop, a desktop computer, a notebook, a device-to-device (D2D) device, a vehicle to everything (V2X) device, a smartphone, a foldable phone, a smart TV, a tablet, an immersive device, and an internet of things (IoT) device.

In an embodiment, the UE (100) includes a processor (110), a communicator (120), a memory (130), and a controller (140). The processor (110) is coupled with the communicator (120), the memory (130), and the disaster condition handling controller (140). In an embodiment, the controller (140) initiates the wait timer upon selecting the FPLMN (300) to receive the disaster roaming service. Further, the controller (140) determines that at least one of: the MS is registered via a non-3GPP access or a 3GPP access to another allowable PLMN, the FPLMN (300) has stopped broadcasting the disaster related indication, and the FPLMN (300) has stopped broadcasting the PLMN with the disaster condition. Based on the determination, the controller (140) stops the wait timer and performs the PLMN selection procedure

In another embodiment, the controller (140) detects that an emergency service is initiated and stop the wait timer based on the detection. The wait timer is initiated upon selecting the FPLMN (300) to receive disaster roaming service.

The controller (140) is physically implemented by analog or digital circuits such as logic gates, integrated circuits, microprocessors, microcontrollers, memory circuits, passive electronic components, active electronic components, optical components, hardwired circuits, or the like, and may optionally be driven by firmware.

Further, the processor (110) is configured to execute instructions stored in the memory (130) and to perform various processes. The communicator (120) is configured for communicating internally between internal hardware components and with external devices via one or more networks. The memory (130) also stores instructions to be executed by the processor (110). The memory (130) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (130) may, in some examples, be considered a non-transitory storage medium. The term “non-transitory” may indicate that the storage medium is not embodied in a carrier wave or a propagated signal. However, the term “non-transitory” may not be interpreted that the memory (130) is non-movable. In certain examples, a non-transitory storage medium may store data that can, over time, change (e.g., in random access memory (RAM) or cache).

Further, at least one of the pluralities of modules/controller may be implemented through the AI model using a data driven controller (not shown). The data driven controller can be a ML model based controller and AI model based controller. A function associated with the AI model may be performed through the non-volatile memory, the volatile memory, and the processor (110). The processor (110) may include one or a plurality of processors. At this time, one or a plurality of processors may be a general purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU).

The one or a plurality of processors control the processing of the input data in accordance with a predefined operating rule or AI model stored in the non-volatile memory and the volatile memory. The predefined operating rule or artificial intelligence model is provided through training or learning.

Here, being provided through learning means that a predefined operating rule or AI model of a desired characteristic is made by applying a learning algorithm to a plurality of learning data. The learning may be performed in a device itself in which AI according to an embodiment is performed, and/o may be implemented through a separate server/system.

The AI model may comprise of a plurality of neural network layers. Each layer has a plurality of weight values, and performs a layer operation through calculation of a previous layer and an operation of a plurality of weights. Examples of neural networks include, but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks.

The learning algorithm is a method for training a predetermined target device (for example, a robot) using a plurality of learning data to cause, allow, or control the target device to make a determination or prediction. Examples of learning algorithms include, but are not limited to, supervised learning, unsupervised learning, semi-supervised learning, or reinforcement learning.

Although FIG. 3 illustrates various hardware components of the UE (100) but it is to be understood that other embodiments are not limited thereon. In other embodiments, the electronic device UE (100) may include less or more number of components. Further, the labels or names of the components are used only for illustrative purpose and does not limit the scope of the present disclosure. One or more components can be combined together to perform same or substantially similar function in the UE (100).

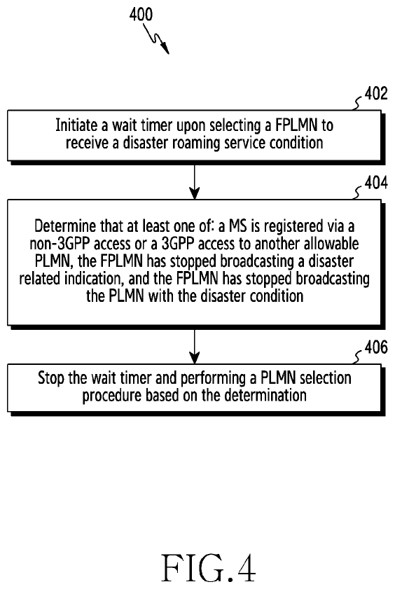

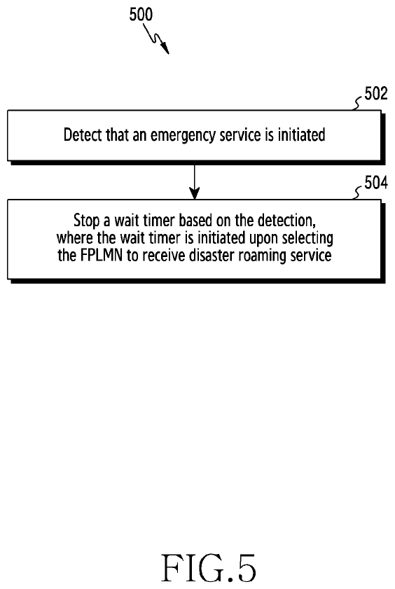

FIG. 4 and FIG. 5 are flow charts (400 and 500) illustrating methods for handling operation of the UE (100) during the disaster situation based on the wait timer according to embodiments as disclosed herein.

As shown in the FIG. 4, the operations (402-406) are performed by the controller (140). At 402, the method includes initiating the wait timer upon selecting the FPLMN (300) to receive the disaster roaming service. At 404, the method includes determining that at least one of: the MS is registered via the non-3GPP access or the 3GPP access to another allowable PLMN, the FPLMN (300) has stopped broadcasting the disaster related indication, and the FPLMN (300) has stopped broadcasting the PLMN with the disaster condition. At 406, the method includes stopping the wait timer and performing the PLMN selection procedure based on the determination.

As shown in the FIG. 5, the operations (502 and 504) are performed by the controller (140). At 502, the method includes detecting that the emergency service is initiated. At 504, the method includes stopping the wait timer based on the detection. The wait timer is initiated upon selecting a FPLMN (300) to receive disaster roaming service.

The provided method is implemented in a wireless communication network (e.g., 4G network, 5G network, 6G network, an open radio access network (ORAN) network or the like). The provided method optimizes the operations in disaster situations.

The various actions, acts, blocks, steps, or the like in the flow charts (400 and 500) may be performed in the order presented, in a different order or simultaneously. Further, in some embodiments, some of the actions, acts, blocks, steps, or the like may be omitted, added, modified, skipped, or the like without departing from the scope of the present disclosure.

The embodiments disclosed herein can be implemented through at least one software program running on at least one hardware device and performing network management functions to control the elements. The elements can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of at least one embodiment, those skilled in the art will recognize that the embodiments herein can be practiced with modification within the scope of the embodiments as described herein.

Although the present disclosure has been described with various embodiments, various changes and modifications may be suggested to one skilled in the art. It is intended that the present disclosure encompass such changes and modifications as fall within the scope of the appended claims.

What is claimed is:

1. A method for handling operation of a user equipment (UE) during a disaster situation, the method comprising:
initiating, by the UE, a wait timer upon selecting a forbidden public land mobile network (FPLMN) to receive a disaster roaming service;
determining, by the UE, a condition based on that at least one of:
whether a mobile station (MS) is registered, via a non-3^{rd} generation partnership project (3GPP) access or a 3GPP access, to an allowable PLMN,
the FPLMN has stopped broadcasting a disaster related indication, or
the FPLMN has stopped broadcasting the allowable PLMN with a disaster condition; and
stopping, by the UE, the wait timer and performing a PLMN selection procedure based on the determined condition.

2. The method of claim 1, wherein the wait timer is a timer started with a generated random number within a disaster roaming wait range configured by a home public land mobile network (HPLMN).

3. A method for handling an operation of a user equipment (UE) during a disaster situation, the method comprising:
detecting, by the UE, that an emergency service is initiated; and
stopping, by the UE, a wait timer based on a detection that the emergency service is initiated, wherein the wait timer is initiated upon selecting a forbidden public land mobile network (FPLMN) to receive a disaster roaming service.

4. The method of claim 3, wherein the wait timer is a timer started with a generated random number within a disaster roaming wait range configured by a home public land mobile network (HPLMN).

5. A user equipment (UE), the UE comprising:
a processor;
memory; and
a controller coupled with the processor and the memory, the controller configured to:
initiate a wait timer upon selecting a forbidden public land mobile network (FPLMN) to receive a disaster roaming service,
determine a condition based on that at least one of:
whether a mobile station (MS) is registered, via a non-3^{rd} generation partnership project (3GPP) access or a 3GPP access, to an allowable PLMN,
the FPLMN has stopped broadcasting a disaster related indication, or
the FPLMN has stopped broadcasting the allowable PLMN with a disaster condition, and
stop the wait timer and perform a PLMN selection procedure based on the determined condition.

6. The UE of claim 5, wherein the wait timer is a timer started with a generated random number within a disaster roaming wait range configured by a home public land mobile network (HPLMN).

7. A user equipment (UE), the UE comprising:
a processor;
memory; and
a controller coupled with the processor and the memory, the controller configured to:
detect that an emergency service is initiated, and
stop a wait timer based on a detection that the emergency service is initiated, wherein the wait timer is initiated upon selecting a forbidden public land mobile network (FPLMN) to receive a disaster roaming service.

8. The UE of claim 7, wherein the wait timer is a timer started with a generated random number within a disaster roaming wait range configured by a home public land mobile network (HPLMN).
